(19) United States
(12) Patent Application Publication
(10) Pub. No.: US 2017/0231401 A1
(43) Pub. Date: Aug. 17, 2017

(54) MATTRESS PANELS INCLUDING ANTIMICROBIAL TREATED FIBERS AND/OR FOAMS

(71) Applicant: DREAMWELL, LTD., Las Vegas, NV (US)

(72) Inventor: Sheri L. McGuire, Duluth, GA (US)

(21) Appl. No.: 15/433,673

(22) Filed: Feb. 15, 2017

Related U.S. Application Data
(60) Provisional application No. 62/295,370, filed on Feb. 15, 2016.

(51) Int. Cl. A47C 31/00; A01N 59/16; A01N 25/16; A01N 25/10

(52) U.S. Cl. CPC A47C 31/007; A01N 25/10; A01N 59/16; A01N 25/16; A47C 31/001

(57) ABSTRACT

Mattress assemblies including antimicrobial panels formed of porous foam or fibers generally include an antimicrobial including a polymer in an amount from 90 to 99.9 weight percent, an oxidant in an amount from 0.004 to 1 weight percent, and a silver metal from 0.002 to 1 weight percent, wherein the weight percent is based on a total weight of the antimicrobial.

### CROSS REFERENCE TO RELATED APPLICATIONS

This Non-Provisional application claims the benefit of U.S. Provisional Patent Application Ser. No. 62/295,370, filed Feb. 15, 2016, which is fully incorporated by reference herein in its entirety.

### BACKGROUND

The present disclosure generally relates to mattress panels including antimicrobial treated fiber and/or foams.

### BRIEF SUMMARY

Disclosed herein are mattress assemblies including porous gel infused foam or fiber panels. In one or more embodiments, the mattress assembly includes a polyurethane foam layer including a porous foam body including a plurality of air pockets; and a gel and an antimicrobial intermixed and infused with the foam body such that the gel and the antimicrobial occupies air pockets of the porous foam body, wherein the antimicrobial comprises a silver compound.

In one or more embodiments, the mattress assembly includes a fiber batting layer having a top planar surface and a bottom planar surface, the fiber batting layer including a plurality of substantially vertically oriented flame retardant and antimicrobial treated fibers extending from the top surface to the bottom surface, wherein the antimicrobial comprises a silver nanoparticulate powder of less than 10 microns.

The disclosure may be understood more readily by reference to the following detailed description of the various features of the disclosure and the examples included therein.

### DETAILED DESCRIPTION

Disclosed herein are antimicrobial fiber and/or foam panels for use in cushioning articles. By way of example, the antimicrobial panels can be employed in mattresses as a fire resistant batting material. In antimicrobial fiber panels, the fibers are substantially vertically oriented and at least portions are flame retardant treated fibers. By use of the term “treated” it is meant that a fire retardant and/or antimicrobial is applied to the fiber, wherein the fibers by themselves may have varying degrees of flame retardancy depending on the composition as well as antimicrobial properties. This would provide consumer benefit of antimicrobial properties but also meet the regulatory FR benefit requirements. Applicants have discovered that orienting the fire retardant treated fibers in a substantially vertical direction increases resiliency and the product's ability to recover due primarily to the change in fiber orientation from horizontal to vertical. The increase in resiliency has been found to translate into higher levels of comfort and product durability. Moreover, increased airflow was observed by orienting the fibers in the substantially vertical direction.

In gel foam panels, the term “treated” means that an antimicrobial is integrally disposed within the gel foam layer.

In the various embodiments disclosed herein, the antimicrobial is a silver polymer commercially available as a silver polymer emulsion from the Dow Corporation under the trade name SILVADUR. The aqueous antibacterial polymer emulsion generally includes, based on the dry weight of the emulsion, from 90 to 99.9 wt % of a polymer A comprising acrylic, styrene-acrylic, or vinyl acetate-acrylic emulsion polymers, from 0.025 to 2 wt % of an oxidant selected from peroxides, halic acids, hypohalous acids, halous acids, perhalic acids, their salts, and combinations thereof, and from 0.002 to 0.5 wt % of silver, wherein the silver is complexed with a copolymer B that comprises from 5 to 95 wt % a heterocyclic containing monomer residue. The silver polymer emulsion is described in detail in U.S. Pat. No. 8,858,926, incorporated herein by reference in its entirety.

In other embodiments, nanotechnology may optionally be used to treat the nonwoven fibers or nonwoven layer with antimicrobial properties. For example, the fibers and gel infused foams can include silver nanoparticles such as those commercially available under the tradename Smart Silver from Nanohorizons, Inc. The silver nanoparticles are generally less than 10 microns and can be formulated integrated during application of the flame retardant or during gel infusion. A dispersion of the silver nanoparticles can be suitably used.

For fiber applications, the antimicrobial may be added to the fibers using application methods known to those skilled in the art. The flame retardant may be singular, or in combination with other finishing chemistries like anti-stats, lubricants, binders, antimicrobials, color, water and oil repellents, surfactants, and other chemical auxiliaries known to the art. Following the application of the chemistry, which may be done using water or other solvents as a vehicle for uniformly distributing the treatment, the fibers can be centrifuged and dried. Exemplary application processes are disclosed in U.S. Pat. No. 7,736,696 to Tintoria-Piana, incorporated herein by reference in its entirety.

By way of example, a closed-loop system and process can used for applying both the antimicrobial and a fire retardant chemicals to the fibers. The untreated fibers are first positioned in a vessel such as a dye machine, which circulates the fire retardant and antimicrobial chemicals. The fire retardant and antimicrobial chemicals may be in the form of a solution, a dispersion or emulsion. In some embodiments, the fire retardant and antimicrobial chemicals are in the form of an aqueous solution. The fire retardant and antimicrobial chemical solution, dispersions, emulsion or otherwise may be at room temperature or at an elevated temperature. In most embodiments, the fire retardant chemical and antimicrobial solution, dispersions, emulsion or otherwise will be at a temperature from about 4° C. to about 100° C.; in other embodiments, from 20 to 50° C. and in still other embodiments, at about ambient temperature.

After absorption of the fire retardant and antimicrobial composition on and/or into the fibers, non-absorbed fire retardant and/or antimicrobial chemicals are recovered and re-used on subsequent batches of fibers. In some embodiments, the re-use of fire retardant and/or antimicrobial chemicals can take place in the same vessel that is used to treat successive batches of fiber. Alternatively, recovery can be achieved by directing the non-absorbed fire retardant and antimicrobial composition into a second dye machine containing additional fibers, or by extracting the fire retardant composition by centrifugation or other means, or by a combination of the two processes. The treated fibers may then be rinsed and dried. Alternatively, the fire retardant and antimicrobial may be applied to the fibers at a subsequent stage of manufacturing, e.g., after blending with the binder fibers or forming the non-woven web, or after the non-woven web has been pleated. The treated fibers can be a carded and cross lapped nonwoven.

In one or more embodiments, the fire retardant and antimicrobial are applied to lyocell fibers. Advantageously because of its high moisture absorption and fiber cross section, it has been discovered that the fire retardant and antimicrobial can be selected to permeate substantially throughout the cross sectional fiber structure unlike many types of fibers where the fire retardant coats exposed surfaces with minimal or no impregnation of the fire retardant into the fiber core. In one embodiment, ammonium polyphosphate can applied in addition to the antimicrobial to the lyocell fiber and has been found to permeate substantially throughout a cross section of the lyocell fiber.

The batting from the treated fibers may be formed using one of several processes for converting a source of fiber into vertically oriented fibers as is generally known in the art. By way of example, the vertically oriented fibers can be formed as described in U.S. Pat. No. 5,702,801, incorporated herein by reference in its entirety. In some embodiments, the peaks of the vertically oriented fibers in the batting material may be brushed or needle punched to improve the entwining of individual fibers of one peak into adjacent peaks. Adjacent peaks of vertically oriented fibers may be of substantially the same height, or alternatively may have different heights in a repeating pattern.

In one or more embodiments, the vertically oriented fibers can be in the form of pleats as discussed above. The pleats are formed from a cross laid non-woven web of fibers that can be less than 5 millimeters (mm) (i.e., about 0.2 inches) thick before pleating and in other embodiments, about 2 mm thick (e.g., a mattress approximately 2000 mm long can have about 500 pleats, each or two sheets). As previously described above, in most embodiments, the fibers are 0.25 to 4 inches long. During manufacture, once pleated, the pleated layer can be cross-needled to provide additional structural strength.

The pleating can provide a pleated layer having a thickness less than about 2 inches. By means of a carding process when the fibers are laid, greater than 75%, and greater than 90% in other embodiments of the fibers of the non-woven web are aligned substantially vertically oriented relative to the plane defined by an underlying mattress or cushioning article, for example.

As noted above, the non-woven web or the pleated layer can also include a binder fiber, which bonds the fibers to form a fiber mat. The binder fiber can be a bi-component fiber having a standard polyester core, e.g., having a melting point of about 250° C. within a low melting temperature polyester surround having a melting point of about 130° C. During manufacture, the non-woven web can be heat treated above the melting temperature of the fiber surround but beneath the temperature of the fiber core to cause the bi-component fibers to bind the fire retardant treated fibers. After pleating, the non-woven web can be cross-needled to enhance its strength. Optionally, the pleated layer may be cut during the manufacturing process as a result of the vertically lapped arrangement of fibers.

Due to the vertical arrangement of the fibers in the pleated layer, when a load is applied to the cushioned article, e.g., mattress, the vertical arrangement of the fibers in the layer supports the load in a spring-like manner, compressing vertically to accommodate the shape of the load without flattening in the neighboring regions. In effect, the vertically oriented fibers, e.g., the vertically lapped formed pleats, act as vertical springs with cross needling to effect limited attachment between pleats but without causing pleats to flatten except under load. Moreover, when load is removed, the vertically oriented fibers readily recover it shape due to the independently spring-like nature of the vertically oriented fibers.

Advantageously, the vertically oriented fibers, e.g., vertically lapped formed pleats, have a low area density, which may result in lighter products and correspondingly less expensive to manufacture and transport.

Exemplary fire retardants include, without limitation, chlorinated flame retardant compounds, such as chlorinated hydrocarbons, chlorinated phosphate esters, chlorinated polyphosphates, chlorinated organic phosphonates, chloroalkyl phosphates, polychlorinated biphenyls, polychlorinated dibenzo-p-dioxins and dibenzofurans are molecules containing a high concentration of chlorine that generally act chemically in the gas phase. They are often used in combination with antimony trioxide and/or zinc borate as a synergist. Three main families of chlorinated compounds include: (a) chlorinated paraffins; (b) chlorinated alkyl phosphates; and (c) chlorinated cycloaliphatic compounds.

Examples of chlorinated compounds include dodecachlorodimethanodibe-nzocyclooctane, tris(2-chloroethyl)phosphate, tris(2-chloro-1-methylethyl)phosphate, tris(2-chloro-1-(chloromethyl)ethyl)phosphate(TDPP), tris(chloropropyl)phosphate, tris (dichloropropyl)phosphat-e, tris(2-chloroethyl)phosphite, ammonium chloride, chlorendic acid, chlorendic anhydride, tris(dichlorobropropyl)phosphite, Bis(hexachlorocyclopentadieno)cyclo-octane, tris(dichloropropyl)phosphite, bis [bis(2-chloroethoxy)-phosphinyl]isop-ropylchloro-ethyl phosphate and MIREX® (1,1a,2,2,3,3a,4,5,5,5a,5b,6-dodecac-hloroocta-hydro-1,3,4-metheno-1H-cyclobuta(cd)pentalene).

Brominated fire retardant compounds, such as brominated organic compounds and brominated hydrocarbons, exhibit fire retardant efficiency in many materials. The three main families of brominated fire retardants include: (a) aliphatic brominated compounds; (b) aromatic brominated compounds; and (c) brominated epoxy fire retardants. Aliphatic brominated compounds include, for example, trisbromoneopentylphosphate, trisbromoneopentyl alcohol, dibromoneopentyl glycol, hexabromocyclohexane, hexabromocyclododecane, tetrabromo cyclopentane, hexabromo cyclohexane, hexabromo cyclooctane, hexabromo cyclodecane and hexabromo cyclododecane. Aromatic brominated compounds include, for example, hexabromo benzene, decabromobiphenyl, octabromodiphenyl oxide, hexabromobenzene, tris (tribromophenyl)triazine, tetrabromobisphenolA bis (2,3 dibromo propyl ether), dibromoneopentyl glycol, poly(pentabromobenzyl acrylate), pentabromodiphenyl ether, octabromodiphenyl oxide, octabromodiphenyl ether, decabromodiphenyl, decabromodiphenyl ethane, decabromodiphenyl oxide, decabromodiphenyl ether, tetrabromobisphenol A and brominated trimethylphenyl indan. Brominated epoxy fire retardants include brominated epoxy oligomers and polymers.

Other brominated fire retardant compounds include brominated diphenyl ethers, polybrominated diphenyl ethers, dimethyl-3-(hydroxymethy-lamino)-3-oxopropyl phosphonate, pentabromo toluene, tetrabromo chlorotoluene, pentabromo phenol, tribromo aniline, dibromobenzoic acid, pentabromotoluene, decabromodiphenyl oxide, tribromophenol, hexabromocyclododecane, brominated phosphorous, ammonium bromide, decabromobiphenyl oxide, pentabromobiphenyl oxide, decabromobiphenyl ether, 2,3-dibromopropanol, octabromobiphenyl ether, octabromodiphenyl oxide, tetrabromobiphenyl ether, hexabromocyclododecane, bis(tetrabromophthalimido) ethane, bis(tribromophenoxy)ethane, brominated polystyrene, brominated epoxy oligomer, polypentabromobenzyl acrylate, tetrabromobisphenol compounds, dibromopropylacrylate, dibromohexachlorocyclopentadienocyclooctane, N.sup.1-ethyl(bis)dibromonon-boranedicarboximide, decabromodiphenyloxide, decabromodiphenyl, hexabromocyclohexane, hexabromocyclododecane, tetrabromo bisphenol A, tetrabrombisphenol S, N′N′-ethylbis(dibromononbomene)dicarboximide, hexachlorocyclopentadieno-dibromocyclooctane, tetrabromodipenta-erythrito-1, pentabromoethylbenzene, decabromodiphenyl ether, tetrabromophthalic anhydride, hexabromobiphenyl, octabromobiphenyl, pentabromophenyl benzoate, bis-(2,3-dibromo-1-propyl)phthalate, tris (2,3-dibromopropyl) phosphate, N,N′-ethylene-bis-(tetrabromophthalimide), tetrabromophthalic acid diol [2-hydroxypropyl-oxy-2-2-hydroxyethylethyl-tetrabromophthalate]-, polybrominated biphenyls, tetrabromobisphenol A, tris(2,3-dibromopropyl)phosphate, tris(2-chloroethyl)phosphite, tris(dichlorobromopropyl)phosphite, diethyl phosphite, dicyandiamide pyrophosphate, triphenyl phosphite, ammonium dimethyl phosphate, bis(2,3-dibromopropyl)phosphate, vinylbromide, polypentabromobenzyl acrylate, decabromodiphenyl oxide, pentabromodiphenyl oxide, 2,3-dibromopropanol, octabromodiphenyl oxide, polybrominated dibenzo-p-dioxins, dibenzofurans and bromo-chlorinate paraffins.

Phosphorous-based fire retardants are compounds that include phosphorous, such as halogenated phosphates (chlorinated phosphates, brominated phosphates and the like), non-halogenated phosphates, triphenyl phosphates, phosphate esters, polyols, phosphonium derivatives, phosphonates, phosphoric acid esters and phosphate esters, which are the largest class of phosphorous flame retardant compounds. Phosphorous-based fire retardants are usually composed of a phosphate core to which is bonded alkyl (generally straight chain) or aryl (aromatic ring) groups. Halogenated phosphate compounds are often introduced to decrease total halogen concentration. Non-halogenated phosphate compounds include, for example, red phosphorous, inorganic phosphates, insoluble ammonium phosphate, ammonium polyphosphate, ammonium urea polyphosphate, ammonium orthophosphate, ammonium carbonate phosphate, ammonium urea phosphate, diammonium phosphate, ammonium melamine phosphate, diethylenediamine polyphosphate, dicyandiamide polyphosphate, polyphosphate, urea phosphate, melamine pyrophosphate, melamine orthophosphate, melamine salt of boron-polyphosphate, melamine salt of dimethyl methyl phosphonate, melamine salt of dimethyl hydrogen phosphite, ammonium salt of boronpolyphosphate, urea salt of dimethyl methyl phosphonate, organophosphates, phosphonates and phosphine oxide. Phosphate esters include, for example, trialkyl derivatives, such as triethyl phosphate and trioctyl phosphate, triaryl derivatives, such as triphenyl phosphate, and aryl-alkyl derivatives, such as 2-ethylhexyl-diphenyl phosphate.

Other examples of phosphorous-based fire retardants include methylamine boron-phosphate, cyanuramide phosphate, cresyl diphenyl phosphate, tris(1-chloro-2-propyl) phosphate, tris(2-chloroethyl)phosphate, tris(2,3-dibromopropyl)phosphate, triphenyl phosphate, magnesium phosphate, tricresyl phosphate, hexachlorocyclopentadiene, isopropyl triphenyl phosphate, tricresol phosphate, ethanolamine dimethyl phosphate, cyclic phosphonate ester, monoammonium phosphate and diammonium phosphate, which permit a char formation as a result of esterification of hydroxyl groups with the phosphoric acid, trialkyl phosphates and phosphonates, such as triethyl phosphate and dimethyl, aryl phosphates, such as triaryl phosphates, isopropyl triphenyl phosphate, octylphenyl phosphate, triphenylphosphate, ammonium phosphates, such as ammonium phosphate, ammonium polyphosphate and potassium ammonium phosphate, cyanuramide phosphate, aniline phosphate, trimethylphosphoramide, tris(1-aziridinyl)phosphine oxide, triethylphosphate, Bis(5,5-dimethyl-2-thiono-1,3,2-dioxaphosphorinamyl)oxide, Bis(2-chloroethyl)vinyl phosphate, dimethylphosphono-N-hydroxyme-thyl-3-propionamide, tris(chloropropyl)phosphate, tris(2-butoxyethyl)phosphate, tris (2-chloroethyl) phosphate, tris(2-ethylhexyl)phosphate, tris(chloropropyl)phosphate, tetrakis(hydroxymethyl)phosphonium salts, such as tetrakis(hydroxymethyl) phosphonium chloride and tetrakis(hydroxymethyl)phosphonium sulfate, n-hydroxymethyl-3-(dimethylphosphono-)-propionamide, urea phosphate, melamine pyrophosphate, a melamine salt of boron-polyphosphate, an ammonium salt of boron-polyphosphate, dicyandiamide pyrophosphate, triphenyl phosphite, ammonium dimethyl phosphate, fyroltex HP, melamine orthophosphate, ammonium urea phosphate, ammonium melamine phosphate, a urea salt of dimethyl methyl phosphonate, a melamine salt of dimethyl methyl phosphonate, a melamine salt of dimethyl hydrogen phosphite, polychlorinated biphenyls, a variety of alkyl diaryl phosphates and mixtures of monomeric chloroethyl phosphonates and high boiling phosphonates.

Metal hydroxide fire retardants include inorganic hydroxides, such as aluminum hydroxide, magnesium hydroxide, aluminum trihydroxide (ATH) and hydroxycarbonate.

Melamine-based fire retardants are a family of non-halogenated flame retardants that include three chemical groups: (a) melamine(2,4,6-triamino-1,3,5 triazine); (b) melamine derivatives (including salts with organic or inorganic acids, such as boric acid, cyanuric acid, phosphoric acid or pyro/poly-phosphoric acid); and (c) melamine homologues. Melamine derivatives include, for example, melamine cyanurate (a salt of melamine and cyanuric acid)), melamine-mono-phosphate (a salt of melamine and phosphoric acid), melamine pyrophosphate and melamine polyphosphate. Melamine homologues include melam (1,3,5-triazin-2,4,6-tri-amine-n-(4,6-diamino-1,3,5-triazine-2-yl), melem (2,5,8-triamino 1,3,4,6,7,9,9b-heptaazaphenalene) and melon (poly[8-amino-1,3,4,6,7,9,9b-heptaazaphenalene-2,5-diyl). Other melamine-based fire retardant compounds are set forth hereinabove.

Borate fire retardant compounds include zinc borate, borax (sodium borate), ammonium borate, and calcium borate. Zinc borate is a boron-based fire retardant having the chemical composition xZnOyB2O3zH2O. Zinc borate can be used alone, or in conjunction with other chemical compounds, such as antimony oxide, alumina trihydrate, magnesium hydroxide or red phosphorous. It acts through zinc halide or zinc oxyhalide, which accelerate the decomposition of halogen sources and promote char formation.

Silicon-based materials include linear and branched chain-type silicone with (hydroxy or methoxy) or without (saturated hydrocarbons) functional reactive groups.

Phosphonic acid derivatives include phosphonic acid, ethylenediamine salt of phosphonic acid, tetrakis hydroxymethyl phosphonium chloride and n-methyl dimethylphosphono propionamide.

Examples of intumescent substances include, but are not limited to, ammonium polyphosphate, boric acid, chlorinated paraffin, DI-pentaerythritol, melamine, mono-ammonium phosphate, pentaerythritol, phosphate esters, polytetrafluoroethylene, tributoxyethyl phosphate, triethyl phosphate, tris (2-ethylhexyl) phosphonate, urea, xylene and zinc borate.

Examples of powdered metal containing flame retardant substances, which can be employed alone or in combination with other flame retardant substances, include, but are not limited to, magnesium oxide, magnesium chloride, talcum, alumina hydrate, zinc oxide, zinc borate, alumina trihydrate, alumina magnesium, calcium silicate, sodium silicate, zeolite, magnesium hydroxide, sodium carbonate, calcium carbonate, ammonium molybdate, iron oxide, copper oxide, zinc phosphate, zinc chloride, clay, sodium dihydrogen phosphate, tin, molybdenum and zinc.

Examples of fire retardant substances that can be applied to the fibers also include boric acid, boron oxide, calcium borate, alumina trihydrate (alumina hydroxide), alumina carbonate, hydrated aluminum, aluminum hydroxide, antimony oxide, antimony trioxide, antimony pentoxide, sodium antimonate, magnesium carbonate, potassium fluorotitanate, potassium fluorozirconate, zinc oxide, hunite-hydromagnesite, ammonium octamolybdate, ammonium bromide, ammonium sulfate, ammonium carbonate, ammonium oxylate, barium metaborate, molybdenum trioxide, zinc hydroxystannate, sodium tungstate, sodium antimonate, sodium stannate, sodium aluminate, sodium silicate, sodium bisulfate, ammonium borate, ammonium iodide, tin compounds, molybdic oxide, sodium antimonate, ammonium sulfamate, ammonium silicate, quaternary ammonium hydroxide, aluminum tryhydroxide, tetrabromobisphenol A, titanium compounds, zirconium compounds, other zinc compounds, such as zinc stannate and zinc hydroxy-stannate, dioxins, diethyl phosphite, methylamine boron-phosphate, cyanoquanidine, thiourea, ethyl urea, dicyandiamide and halogen-free phosphonic acid derivatives.

In one or more other embodiments, the antimicrobial is integrated into a gel or a phase change material infused foam. The inclusion of the Silvadur, Smart Silver or the like would create a solution that addressed thermal and also antimicrobial features. In one embodiment, the PCM/Gel solution is proximate to a sleep surface. In one or more embodiments, the silver can be an inorganic commercially available under the trade name Alphasan silver from Milliken Chemical, which is reported to be a silver sodium hydrogen zirconium phosphate. The silver can be mixed with a liquid gel and dispersed consistently throughout a closed cell or open cell foam.

The mattress core or one or more supporting layers is formed from a porous foam body, antimicrobial and gel (or phase change material) that are intermixed such that the gel and antimicrobial occupies portions air pockets within the porous foam body.

In certain embodiments, the primary material includes polyurethane such as foam and visco-elastic foam. The polyurethane may include a chemical combination of polyol and diisocyanate. In certain embodiments, the primary material includes about 2 parts polyol and 1 part diisocyanate. The polyurethane primary material includes a plurality of air pockets giving the material a porous structure. In certain embodiments, the polyurethane primary material has at least one of an open cell and closed cell structure. In one example of a closed cell structure, the polyurethane material is chemically cross-linked and the air pockets or gas filled voids are disposed internally within the polyurethane foam body and have minimal contact with the exterior surface of the body. In one example of an open cell structure, the air pockets are disposed internally within the polyurethane foam body and extend through one or more surfaces. In certain embodiments, the porosity and/or the density of the primary material determines the volume of space occupied by the plurality of air pockets. In certain embodiments, low porosity materials have fewer air pockets than high porosity materials. The level of porosity and/or the number of air pockets may be selected as desired. In certain embodiments, the number of air pockets is increased through one or more reticulation processes. It is these air pockets where the secondary materials, e.g., gel, phase change material and antimicrobial, are disposed.

In certain embodiments, the foam layer has a body made from the primary material and infused with the secondary material such that the secondary material is distributed throughout the interior of the primary material. In certain embodiments, in addition to the antimicrobial, the secondary material includes any suitable elastomer such as a gel without departing from the scope of the invention. In certain embodiments, the secondary material in addition to the antimicrobial includes latex. The secondary material in addition to the antimicrobial may include a polyurethane based gel. The gel may include a chemical combination of polyol and diisocyanate. In certain embodiments, the gel portion includes about 10 parts polyol and 1 part diisocyanate. Exemplary gel materials may include LEVAGEL™ or TECHNOGEL™ made by Technogel Italia Srl, Pozzoleone (VI) Italy, and polyurethane and elastomeric materials manufactured by Dow Chemical Company, Midland, Mich., USA. The secondary material may include polymer material, such as thermoset elastomer and other polymeric materials described in U.S. Pat. Nos. 5,362,834, 6,326,412 and 6,809,143, the entire contents of which are herein incorporated by reference. In certain embodiments, the gel includes, at least one of silicone gel, a PVC gel, a polyorganosiloxane gel, a NCO-prepolymer gel, a polylol gel, a polyurethane gel, a polyisocyanate gel, and a gel including a pyrogenically produced oxide. The gel may be in a solid state or a liquid state. In certain embodiments, the gel may transition from liquid to a solid state on applying heat or pressure.

In certain embodiments, the secondary material fills one or more of the plurality of air pockets within the primary material. In certain embodiments, the air pockets are substantially uniformly located throughout the interior of the primary material and the secondary material fills these pockets and is substantially uniformly distributed throughout the interior of the foam panel. In certain embodiments, the secondary material integrates with the primary material through chemical bonding. In such embodiments, the secondary material is initially in liquid form and combined with the primary material. During curing or hardening, the secondary material may establish a chemical bond with the primary material.

An exemplary process for manufacturing a mattress component including the antimicrobial and the gel is as follows. The process begins with providing a foam body or a body made from any primary material. The foam body is then reticulated to increase the volume and/or the number of air pockets. The reticulated foam body is then combined with the antimicrobial, a liquid gel, or any additional secondary material. In certain embodiments, the foam body is combined with the antimicrobial and liquid gel. In certain embodiments, the foam body or the reticulated foam body is dipped into a tub or vessel containing the antimicrobial and gel in liquid form. The gel and antimicrobial liquid is allowed to seep into the body thereby filling one or more of a plurality of air pockets. In other embodiments, a liquid solution of the antimicrobial and the gel is poured over the foam or reticulated foam body to infuse the antimicrobial and gel into the air pockets. The liquid gel infused into the body is allowed to harden through a curing process. In certain embodiments, the curing process may be stimulated through the application of heat and/or pressure.

The foam body may be reticulated through at least one of a thermal process and a chemical process. An exemplary process begins with placing and enclosing the foam body in a chamber or vessel. The chamber is filled with explosive gas such as hydrogen and oxygen. In certain embodiments, the chamber is evacuated prior to filling with the explosive gas. The explosive gas is ignited through an electric spark or a controlled flame, thereby forming a one or more air pockets within the foam body. In certain embodiments, a controlled flame is passed through the foam body to remove certain portions of the body and thereby create one or more air pockets in those desired regions.

An exemplary chemical process for reticulating a foam body begins with placing the foam body in a caustic bath. In certain embodiments, the caustic bath includes a vessel containing a NaOH solution. The foam body may be allowed to sit in the caustic bath for any duration of time as desired. In certain embodiments, the caustic solution reacts with the foam and removes the foam material from the body, thereby generating a plurality of voids. The foam body is removed from the caustic bath and washed, rinsed and dried.

Some exemplary embodiments of articles in which the antimicrobial gel infused foams and fibers can be used include, but are not limited to, as one or more of the layers defining an innercore, a top layer overlying the innercore, mattress pads, mattress covers, mattress “toppers,” the pillow-top portion of pillow-top mattresses, pillows, and the like. In other embodiments, the flame resistant fiber panels can be employed in mattresses as a batting material.

For the vertically oriented fiber batting material, the fibers to be fire retardant and antimicrobial treated generally have a length of 0.25 to 4 inches; in other examples, a length of 0.5 to 3 inches, and in still other examples, a length of 1.5 to 3 inches. By way of example, for lyocell, rayon and/or polyester fibers, the cut lengths for carding are generally between 1.5 and 3 inches. For natural fibers such as cotton, the fiber length can generally vary from 0.5 to 1.6 inches. The non-woven fiber batting material when vertically oriented can also have a total thickness or loft of 0.5 inches (1.25 centimeters) or greater. While there is no real limitation on how thick the batting can be, for many typical applications, the thickness of the high loft batting need not be higher than 3 inches (7.6 cm), and for many mattress applications less than 2 inches (5 cm) is useful. The flame resistant and antimicrobial panels can also generally have a basis weight of about 5 to 18 ounces per square yard (169 to 610 grams per square meter) and are preferably 8 to 11 ounces per square yard (271 to 373 grams per square meter). The total density of the batting material is generally aligned with the basis weights described above. Denser battings generally do not have the resiliency desired for use as cushioning in mattresses and other articles. As for battings that are less dense, the batting materials are oftentimes bulky to handle during fabrication and are generally compressed into the preferred density range when incorporated into a quilted composite Thinner and denser battings also do not provide the desired softness, aesthetics, and may lack durability in application and with flame retardant and antimicrobial protection.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A mattress assembly comprising:
a polyurethane foam layer comprising a porous foam body including a plurality of air pockets; and
a gel and an antimicrobial intermixed and infused with the foam body such that the gel and the antimicrobial occupies air pockets of the porous foam body, wherein the antimicrobial comprises a silver compound.

2. The mattress assembly of claim 1, wherein the polyurethane is a viscoelastic foam.

3. The mattress assembly of claim 1, wherein the polyurethane foam layer is a closed cell foam.

4. The mattress assembly of claim 1, wherein the polyurethane foam is an open cell foam.

5. The mattress assembly of claim 1, wherein the gel is a silicone gel, a PVC gel, a polyorganosiloxane gel, a NCO-prepolymer gel, a polylol gel, a polyurethane gel, a polyisocyanate gel, and a gel including a pyrogenically produced oxide.

6. The mattress assembly of claim 1, wherein the silver compound comprises a polymer in an amount from 90 to 99.9 weight percent, an oxidant in an amount from 0.004 to 1 weight percent, and a silver metal from 0.002 to 1 weight percent, wherein the weight percent is based on a total weight of the antimicrobial.

7. The mattress assembly of claim 1, wherein the silver compound is silver sodium hydrogen zirconium phosphate.

8. A mattress assembly comprising:
a fiber batting layer having a top planar surface and a bottom planar surface, the fiber batting layer comprising a plurality of substantially vertically oriented flame retardant and antimicrobial treated fibers extending from the top surface to the bottom surface, wherein the antimicrobial comprises a silver nanoparticulate powder of less than 10 microns.

9. The mattress assembly of claim 8, wherein the fibers of the substantially vertically oriented flame retardant treated fibers are selected from the group consisting of polyester, polyolefins, cellulosic fibers and mixtures thereof.

10. The mattress assembly of claim 9, wherein the cellulosic fibers comprise as cotton, rayon, wool, silk, acetate, nylon, lyocell, flax, ramie, jute, angora, kenaf or mixtures thereof.

11. The mattress assembly of claim 8, wherein a loading of the fire retardant material of the substantially vertically oriented flame retardant fibers treated is in an amount effective to meet a flammability standard defined in 16 CFR Part 1633 (2007).

12. The mattress assembly of claim 8, wherein the fire retardant material of the substantially vertically oriented flame retardant treated fibers comprises halogenated compounds, phosphorous containing compounds, sulfate containing compounds, metal hydroxides, borates, silicon based compounds, melamine based compounds, phosphonic acid derivatives, intumescent compounds, and mixtures thereof.

13. The mattress assembly of claim 8, wherein the batting material has a thickness greater than 0.5 inches to 3 inches.

14. The mattress assembly of claim 8, wherein the substantially vertically oriented flame retardant treated fibers comprise lyocell fibers treated with ammonium polyphosphate.

15. The mattress assembly of claim 8, wherein the substantially vertically oriented flame retardant treated fibers are greater than 50 percent of the layer.

16. The mattress assembly of claim 8, wherein the substantially vertically oriented flame retardant treated fibers extending from the top surface to the bottom surface are in the form of pleats.

17. The mattress assembly of claim 8, wherein the substantially vertically oriented flame retardant treated fibers comprise natural fibers.

18. A mattress assembly of claim 8, wherein the fiber layer is a carded and crosslapped nonwoven.
